(19) United States
(12) Patent Application Publication
(10) Pub. No.: US 2004/0095489 A1
(43) Pub. Date: May 20, 2004

(54) Image pickup apparatus, image pickup system, and image pickup method

(75) Inventor: Satoru Hirose, Osaka (JP)

Correspondence Address: McDERMOTT, WILL & EMERY, 600 13th Street, N.W., Washington, DC, 20005, US

(73) Assignee: Minolta Co., Ltd.

(21) Appl. No.: 10/462,648

(22) Filed: Jun. 17, 2003

(30) Foreign Application Priority Data
Nov. 19, 2002 (JP) P2002-335041

(51) Int. Cl. H04N 5/225

(52) U.S. Cl. 348/262

(57) ABSTRACT

A image pickup system has an image pickup apparatus including a spectral prism and two image pickup devices. The spectral prism has a spectral face formed from a dichroic film. The spectral face has spectral transmission characteristics of color filters disposed for each pixel in the image pickup devices, that is, a wavelength characteristic which divides a wavelength band of each of RGB colors. Incident light from a subject is split into two optical paths by the spectral face, and spectral images of the subject traveling in the optical paths are obtained by the image pickup devices. Thus, a plurality of spectral images can be obtained in one shot with excellent efficiency regarding the quantity of light.

This application is based on application No. 2002-335041 filed in Japan, the contents of which are hereby incorporated by reference.

### BACKGROUND OF THE INVENTION

1. Field of the Invention

The present invention relates to an image pickup apparatus for obtaining a plurality of spectral images in one shot.

2. Description of the Background Art

A multi-band camera (image pickup apparatus) is an input device for faithfully reproducing colors of an object (subject), and is a camera for accurately obtaining the colors of the object by performing arithmetic operation on the basis of multicolor information of four or more colors obtained by image pickup.

There is an image pickup apparatus of a type in which a multicolor color wheel is inserted in an optical path extending from a subject to an image pickup device and rotated, and pictures are sequentially taken in accordance with the rotation. Since the sequential image pickup is necessary in this type, one-shot image pickup cannot be performed.

There is an image pickup apparatus capable of performing one-shot image pickup, in which incident light is split into two optical paths by a semitransparent mirror, the same CCD of RGB is disposed in each of the optical paths, and two filters having predetermined wavelength characteristics are disposed in each of the optical paths (see the following Literature 1). With the configuration, a spectral image of six colors can be obtained on the basis of data generated by the two CCDs.

### LITERATURE 1

Hiroshi Ishimaru and six others, “Development of One Shot Multi Spectral Camera System using Plural RGB Cameras”, The 61th Annual Meeting of the Japan Society of Applied Physics, Digest, September 2000, p887.

In the technique of Literature 1, however, at the time of splitting incident light by the semitransparent mirror, the quantity of light is reduced to the half in each of the optical paths, each of the filters disposed in each of the optical paths in which the quantity of light is reduced to the half further cuts light of a specific wavelength. Consequently, the quantity of light reaching each of the CCDs becomes small, and efficiency is low.

### SUMMARY OF THE INVENTION

The present invention is directed to an image pickup apparatus.

According to the present invention, image pickup apparatus includes: (a) a splitting element for splitting incident light of a subject into a plurality of optical paths by a dichroic film and emitting split light; and (b) a plurality of image pickup sensors each provided on the plurality of optical paths split by the splitting element, wherein each of the plurality of image pickup sensors has a spectral sensitivity characteristic having a plurality of wavelength bands, and the dichroic film has a wavelength characteristic of dividing light components in at least one of the plurality of wavelength bands into a first portion and a second portion, and selectively transmitting the first portion. Thus, a plurality of spectral images can be obtained in one shot with excellent efficiency regarding the quantity of light.

In a preferred embodiment of the present invention, in the apparatus, the plurality of wavelength bands are three wavelength bands corresponding to three primary colors. Consequently, by using a general color image pickup device, spectral images can be easily obtained.

The present invention is also directed to an image pickup system and an image pickup method.

Therefore, an object of the present invention is to provide an image pickup technique capable of obtaining a plurality of spectral images in one shot with excellent efficiency regarding the quantity of light.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the appearance of an image pickup system according to a first embodiment of the present invention;

FIG. 2 shows the configuration of the main part of the image pickup system;

FIGS. 3A to 3C are graphs for describing a method of obtaining a spectral image by an image pickup apparatus;

FIG. 4 is a flowchart for describing the operation of the image pickup system of FIG. 2;

FIGS. 5A to 5C are graphs for describing another method of obtaining a spectral image;

FIG. 6 illustrates a method of producing a spectral prism 31A;

FIGS. 7A and 7B are graphs for describing the method of producing the spectral prism of FIG. 6;

FIGS. 8A and 8B are graphs for describing the method of producing the spectral prism of FIG. 6;

FIGS. 9A to 9C are graphs for describing a method of obtaining a spectral image of five colors;

FIGS. 10A to 10C are graphs for describing the method of obtaining a spectral image of five colors;

FIGS. 11A to 11C are graphs for describing a method of obtaining a spectral image of four colors;

FIGS. 12A to 12C are graphs for describing the method of obtaining a spectral image of four colors;

FIG. 13 shows the configuration of the main part of an image pickup system according to a second embodiment of the present invention;

FIGS. 14A to 14C are graphs for describing a method of obtaining a spectral image by the image pickup apparatus;

FIGS. 15A to 15C are graphs for describing the method of obtaining a spectral image by the image pickup apparatus;

FIG. 16 is a flowchart for describing the operation of the image pickup system of FIG. 13; and

FIGS. 17A to 17E illustrate spectral prisms according to modifications of the present invention.

### DESCRIPTION OF THE PREFERRED EMBODIMENTS

### First Embodiment

### Configuration of Main Part of Image Pickup System

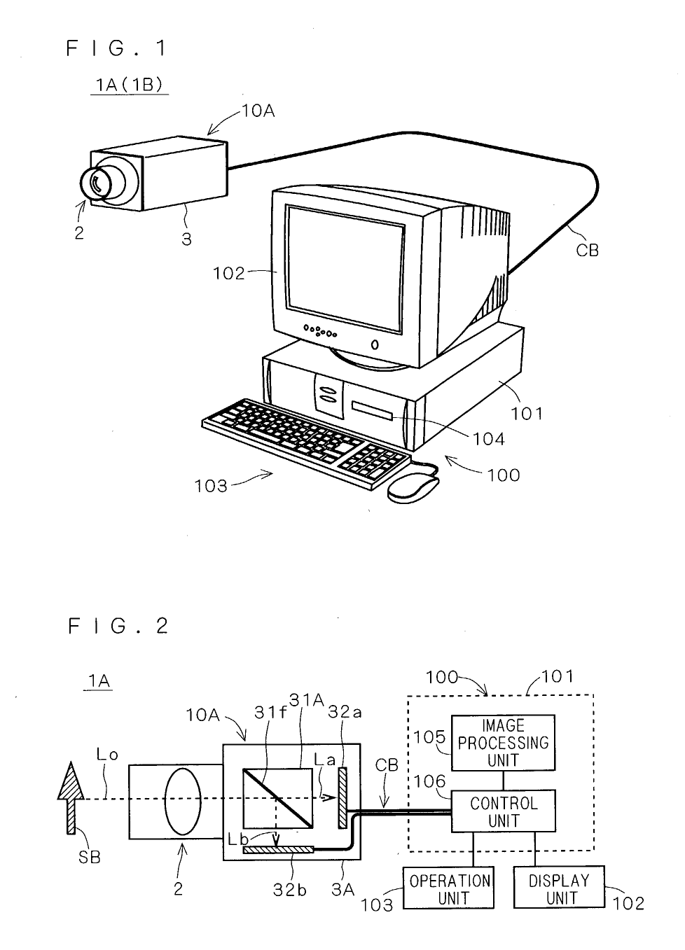

FIG. 1 is a perspective view showing the appearance of an image pickup system 1A according to a first embodiment of the present invention.

The image pickup system IA has an image pickup apparatus 10A and a personal computer 100. The image pickup apparatus 10A and the personal computer 100 are electrically connected to each other via a cable CB, so that the image pickup apparatus 10A and the personal computer 100 can transmit/receive data to/from each other. Herein, although they are electrically connected to each other via the cable CB, they may be connected to each other by radio or via a network constructed by a wire circuit, a radio circuit or the like.

The image pickup apparatus 10A is mainly formed from a taking lens system 2 and a box-shaped camera body 3A, and is used as, for example, a camera for analysis which analyzes colors of the surface of the subject. The image pickup apparatus 10A splits light emitted from the surface of the subject into wavelength bands corresponding to a plurality of colors, which will be described later. By exposing the light, a multi-band image, that is, spectral image data can be generated.

The image pickup apparatus 10A transmits the generated spectral image data to the personal computer 100 via the cable CB.

The personal computer 100 functions as an information processing apparatus, and has: a personal computer body 101 functioning as an information processor for inputting/outputting various signals and data, and performing various data processes; a display unit 102 for visibly outputting various images; and an operation unit 103 formed from a keyboard, a mouse and the like. Although not shown, the personal computer body 101 is connected to each of the display unit 102 and the operation unit 103 so as to be able to transmit/receive various signals and data.

FIG. 2 shows the configuration of the main part of the image pickup system 1A.

The camera body 3A of the image pickup apparatus 10A has a spectral prism 31A, and two image pickup devices 32a and 32b.

The spectral prism 31A has a rectangular parallelepiped shape, and has therein a spectral face 31f formed from a dichroic film. The spectral face 31f functions as a dichroic filter. By making the spectral face 31f tilted by about 45 degrees with respect to incident light Lo from a subject SB entering the spectral prism 31A, the incident light Lo is split into an optical path La in which the incident light Lo transmits in the same direction as the travel direction of the incident light Lo and an optical path Lb in which the incident light Lo is reflected in the direction orthogonal to the travel direction of the incident light Lo.

The image pickup device 32 (32a and 32b) functions as an image pickup sensor, and takes the form of a general color CCD in which color filters of red (R), green (G) and blue (B) are arranged, for example, in a Bayer array for each pixel (photoelectric cell) as a minimum area unit of photo-reception. To be specific, in each of the image pickup devices 32a and 32b, three color filters of RGB corresponding to the wavelength bands of three primary colors are arranged on a photoelectric cell array. The image pickup devices 32a and 32b are disposed on the optical paths La and Lb split by the spectral prism 31A. The image pickup device 32a obtains a spectral image of the subject SB traveling in one optical path La, and the image pickup device 32b obtains a spectral image of the subject SB traveling in the other optical path Lb (which will be described in detail later).

The personal computer body 101 of the personal computer 100 has an image processing unit 105, and a control unit 106 electrically connected to the image processing unit 105.

The image processing unit 105 performs image processes such as pixel interpolation and y correction as necessary on the spectral image data transmitted from the image pickup apparatus 10A via the cable CB.

The control unit 106 controls the operation of the image pickup apparatus 10A, and deals various data regarding multi-band image information generated by the image pickup apparatus 10A. In this case, by the operation of the user of the operating unit 103, various control signals can be transmitted from the personal computer body 101 to the image pickup apparatus 10A via the cable CB. For example, by a control signal from the personal computer body 101, start and stop of image pickup in the image pickup apparatus 10A, generation of spectral image data based on color information of a subject, and the like can be controlled.

The personal computer body 101 has a hard disk (not shown) and a drive 104 provided in the front face, into which a recording medium such as an optical disk can be inserted. By the operation of the user of the operating unit 103, spectral image data received via the cable CB from the image pickup apparatus 10A can be stored into a hard disk or a recording medium.

In the personal computer 100 having functions as described above, by visibly outputting various images based on the spectral image data in the display unit 102, colors of the surface of the subject can be analyzed. For example, in the case where the colors of the surface of the subject are obtained as color information of a number of colors, by displaying a histogram (luminance distribution) for each color on the display unit 102, the colors of the surface of the subject can be analyzed.

A method of obtaining a spectral image by the image pickup apparatus 10A having the above configuration will be described below.

### Method of Obtaining Spectral Image

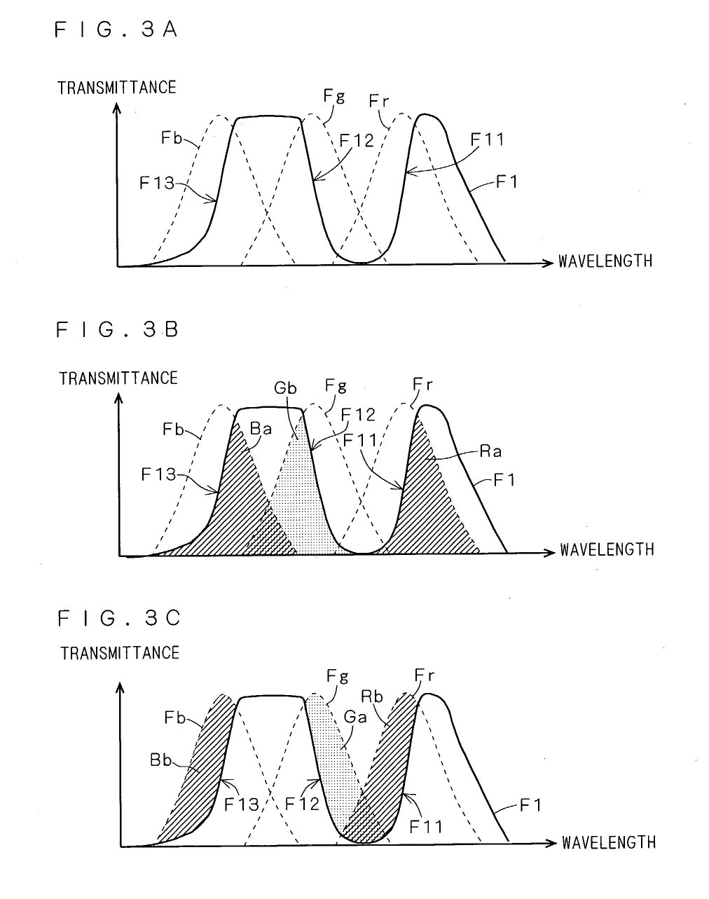

FIGS. 3A to 3C are graphs for describing a method of obtaining a spectral image by the image pickup apparatus 10A. In FIGS. 3A to 3C, the lateral axis indicates wavelength and the vertical axis indicates transmittance.

As shown in FIG. 3A, the color filters for each RGB color arranged in the image pickup device 32 have spectral transmittance characteristics Fr, Fg and Fb (shown by imaginary lines) each having a spectral sensitivity distribution in which the transmittance gradually attenuates after the peak of the wavelength. On the other hand, the spectral face 31f of the dichroic prism 31A has a wavelength characteristic F1 which divides each of the spectral transmittance characteristics Fr, Fg and Fb of the color filters.of the image pickup device 32.

Concretely, light components in the wavelength band of the color R expressed by the spectral transmission characteristic Fr are divided into first and second portions in the wavelength direction by a rising portion (inclined portion) F11 which changes from the minimum transmittance to the maximum transmittance in the wavelength characteristic F1, and a portion corresponding to the high wavelength side selectively transmits. On the other hand, light components in the wavelength band of the color G expressed by the spectral transmission characteristic Fg are divided into first and second portions by an inclined portion F12, and a portion corresponding to the low wavelength side selectively transmits. Light components in the wavelength band of the color B expressed by the spectral transmission characteristic Fb are divided into first and second portions by an inclined portion F13, and a portion corresponding to the high wavelength side selectively transmits. By the wavelength characteristic F1 of the spectral face 31f, light components on the side lower than the curve expressing the wavelength characteristic F1 propagate in the optical path La in which the incident light Lo passes and light components on the side upper than the curve expressing the wavelength characteristic F1 propagate in the optical path Lb in which the incident light Lo is reflected. In such a manner, the light components in the optical paths La and Lb have a complementary relation.

Therefore, a light image of the subject SB transmitting the spectral face 31f and propagating on the optical path La is obtained by the image pickup device 32a as shown in FIG. 3B. Specifically, by R pixels of the image pickup device 32a, a spectral image in a wavelength band Ra (hatched portion) on the right side (high band side) of the inclined portion F11 is obtained. By G pixels of the image pickup device 32a, a spectral image in a wavelength band Gb (halftone dotted portion) on the left side (low band side) of the inclined portion F12 is obtained. Further, by B pixels of the image pickup device 32a, a spectral image in a wavelength band Ba (hatched portion) on the right side (high band side) of the inclined portion F13 is obtained.

A light image of the subject SB reflected by the spectral face 3 If and propagating on the optical path Lb is obtained by the image pickup device 32b as shown in FIG. 3C. Specifically, by R pixels of the image pickup device 32b, a spectral image in a wavelength band Rb (hatched portion) on the left side (low band side) of the inclined portion F11 is obtained. By G pixels of the image pickup device 32a, a spectral image in a wavelength band Ga (halftone dotted portion) on the right side (high band side) of the inclined portion F12 is obtained. Further, by B pixels of the image pickup device 32b, a spectral image in a wavelength band Bb (hatched portion) on the left side (low band side) of the inclined portion F13 is obtained.

The incident light Lo transmits or is reflected by the spectral prism 31A on the basis of the wavelength characteristic F1 except for a very small light amount loss such as absorption of a glass base material or the like, so that spectral images of six wavelength bands Ra, Rb, Ga, Gb, Ba and Bb, that is, six colors can be obtained with high efficiency regarding the quantity of light by the two image pickup devices 32a and 32b.

### Operation of Image Pickup System 1A

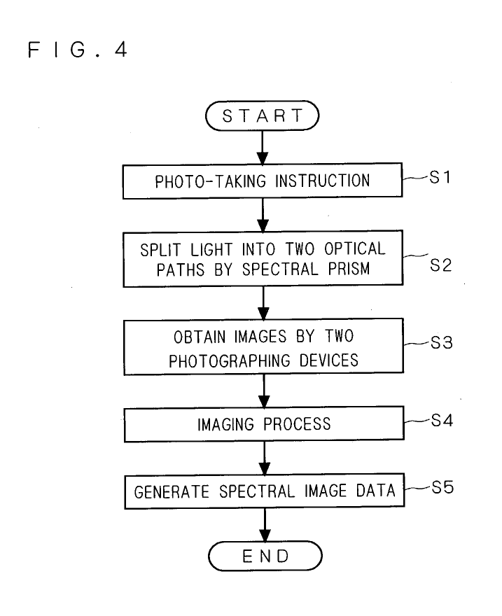

FIG. 4 shows a flowchart for describing the operation of the image pickup system 1A.

First, the user variously operates the operation unit 103 of the personal computer 100, so that the personal computer 100 instructs the image pickup apparatus 10A to perform image pickup (step S1). In this case, an image pickup instruction signal generated by the control unit 106 is transmitted to the image pickup apparatus 10A via the cable CB, thereby giving the instruction.

In step S2, the incident light Lo from the subject SB is split into the two optical paths La and Lb by the spectral prism 31A having the dichroic film.

In step S3, images are obtained by the two image pickup devices 32a and 32b for receiving a light image of the subject SB in the optical paths La and Lb split in step S2.

In step S4, an image process such as pixel interpolation is performed by the image processing unit 105 on the image data obtained in step S3.

In step S5, by the image process performed in step S4, spectral image data is generated. In this case, by the spectral transmission characteristic F1 of the spectral face 31f which divides each of the three spectral transmission characteristics Fr, Fg and Fb in the image pickup device 32, spectral image data of six colors (three colors×2) is generated by one shot image pickup. On the basis of the generated spectral image data, for example, by displaying an image on the display unit 102, the user can recognize the image.

Since a light image of the subject split by the spectral face 31f formed from the dichroic film is obtained by the configuration and operation of the image pickup system 1A, a plurality of spectral images can be obtained in one shot with high efficiency regarding the quantity of light.

Since both the two image pickup devices 32a and 32b have the Bayer arrays, that is, the array patterns of the RGB color filters are the same, spectral images obtained by the image pickup devices can be easily compared with each other and examined.

Further, the dichroic film has the wavelength characteristic F1 which divides each of the wavelength bands Fr, Fg and Fb, so that a number of spectral images can be efficiently obtained in one shot with low cost.

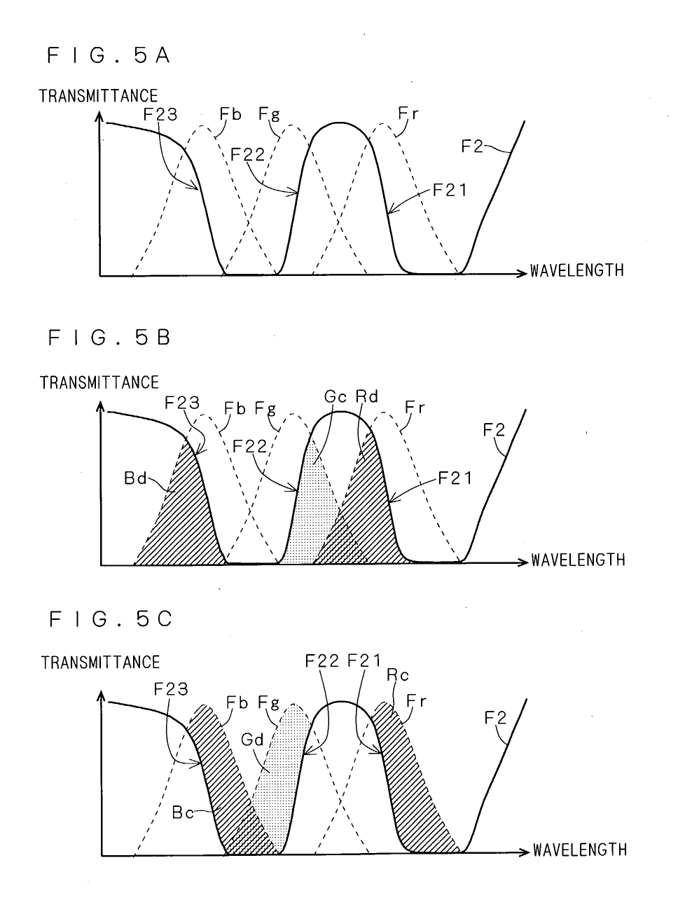

The dichroic film of the spectral face 31f of the spectral prism 21A does not need to essentially have the spectral transmission characteristic F1 shown in FIGS. 3A to 3C but may have a spectral transmission characteristic F2 shown in FIGS. 5A to 5C.

As shown in FIG. 5A, the light components of the wavelength band of the color R expressed by the spectral transmission characteristic Fr are divided into first and second portions by an inclined portion F21 of the wavelength characteristic F2, and a portion corresponding to the low wavelength side selectively transmits. On the other hand, the light components of the wavelength band of the color G expressed by the spectral transmission characteristic Fg are divided into first and second portions by an inclined portion F22, and a portion corresponding to the high wavelength side selectively transmits. The light components of the wavelength band of the color B expressed by the spectral transmission characteristic Fb are divided into first and second portions by an inclined portion F23, and a portion corresponding to the low wavelength side selectively transmits. By the wavelength characteristic F2, in the optical path La in which the incident light Lo propagates, light components on the side lower than the curve expressing the wavelength characteristic F2 propagate. In the optical path Lb to which the incident light Lo is reflected, light components on the side upper than the curve of the wavelength characteristic F2 propagate.

Therefore, a light image of the subject SB transmitting the spectral face 31f and propagating on the optical path La is obtained by the image pickup device 32a as shown in FIG. 5B. Specifically, by R pixels of the image pickup device 32a, a spectral image in a wavelength band Rd (hatched portion) on the left side (low band side) of the inclined portion F21 is obtained. By G pixels of the image pickup device 32a, a spectral image in a wavelength band Gc (halftone dotted portion) on the right side (high band side) of the inclined portion F22 is obtained. Further, by B pixels of the image pickup device 32a, a spectral image in a wavelength band Bd (hatched portion) on the left side (low band side) of the inclined portion F23 is obtained.

A light image of the subject SB reflected by the spectral face 31f and propagating on the optical path Lb is obtained by the image pickup device 32b as shown in FIG. 5C. Specifically, by R pixels of the image pickup device 32b, a spectral image in a wavelength band Rc (hatched portion) on the right side (high band side) of the inclined portion F21 is obtained. By G pixels of the image pickup device 32b, a spectral image in a wavelength band Gd (halftone dotted portion) on the left side (low band side) of the inclined portion F22 is obtained. Further, by B pixels of the image pickup device 32b, a spectral image in a wavelength band Bc (hatched portion) on the right side (high band side) of the inclined portion F23 is obtained.

Also by the spectral prism 31A having the wavelength characteristic F2 shown in FIGS. 5A to 5C, spectral images of six wavelength bands Rc, Rd, Gc, Gd, Bc and Bd, that is, six colors can be obtained with excellent efficiency regarding the quantity of light in the two image pickup devices 32a and 32b.

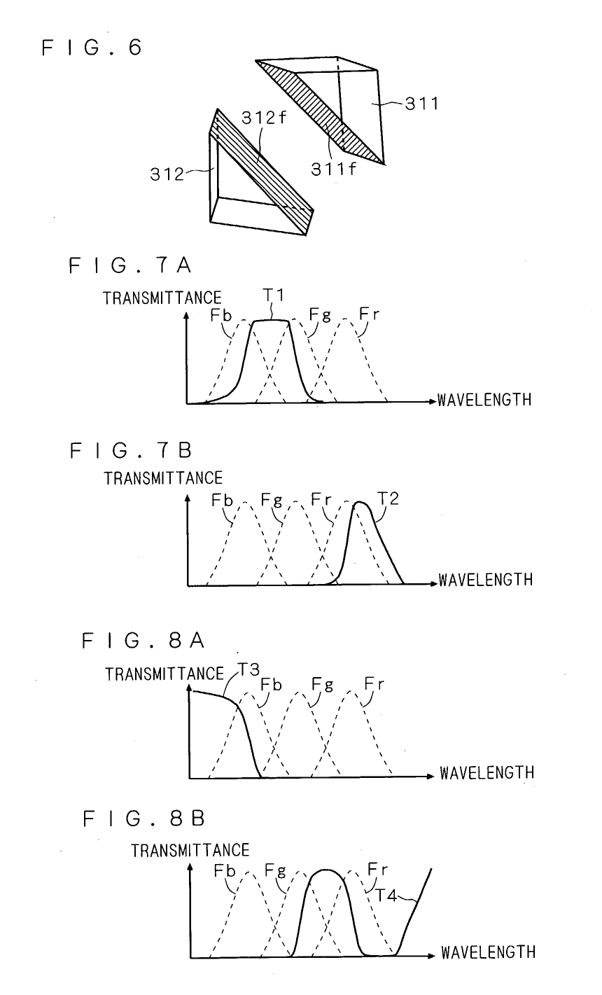

The wavelength characteristics FI and F2 of the spectral face 31f shown in FIGS. 3A to 3C and FIGS. 5A to 5C do not need to be essentially realized by a single dichroic film but may be realized by two dichroic films adhered to each other. For example, to produce the spectral prism 31A (FIG. 2), as shown in FIG. 6, two prisms 311 and 312 are adhered to each other with surfaces 311f and 312f coated with dichroic films. In this case, by adhering the coated surfaces 311f having a wavelength characteristic T1 shown in FIG. 7A and the coated surface 312f having a wavelength characteristic T2 shown in FIG. 7B to each other, the spectral transmission characteristic F1 shown in FIGS. 3A to 3C can be realized. By adhering the coated surface 311f having a wavelength characteristic T3 shown in FIG. 8A and the coated surface 312f having a wavelength characteristic T4 shown in FIG. 8B to each other, the spectral transmission characteristic F2 shown in FIGS. 5A to 5C can be realized.

Even such relatively complicated wavelength characteristics F1 and F2 can be easily and appropriately realized by adhering the coated surfaces having the wavelength characteristics T1, T2, T3 and T4 which are simplified and easily generated.

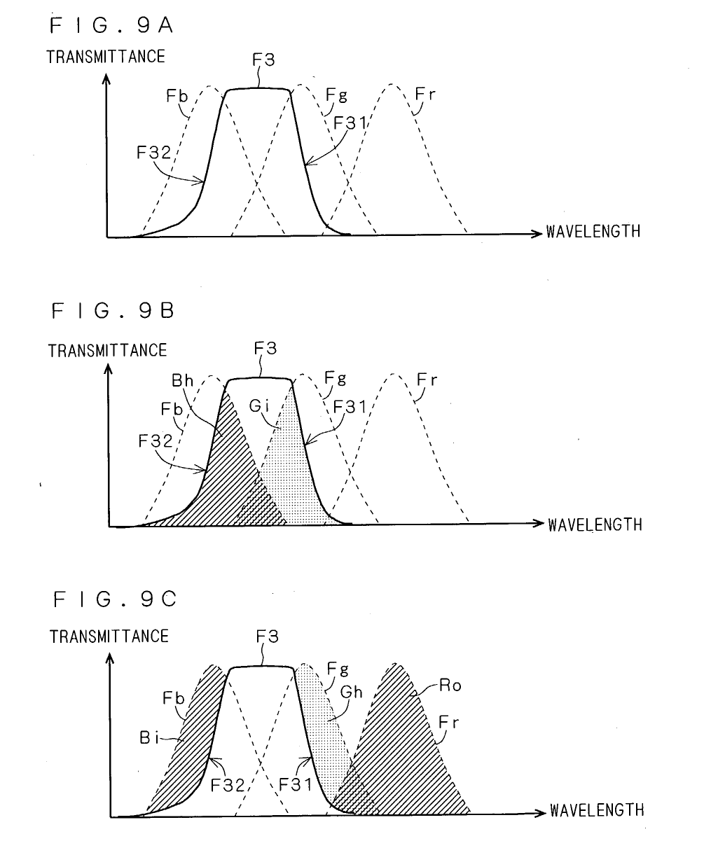

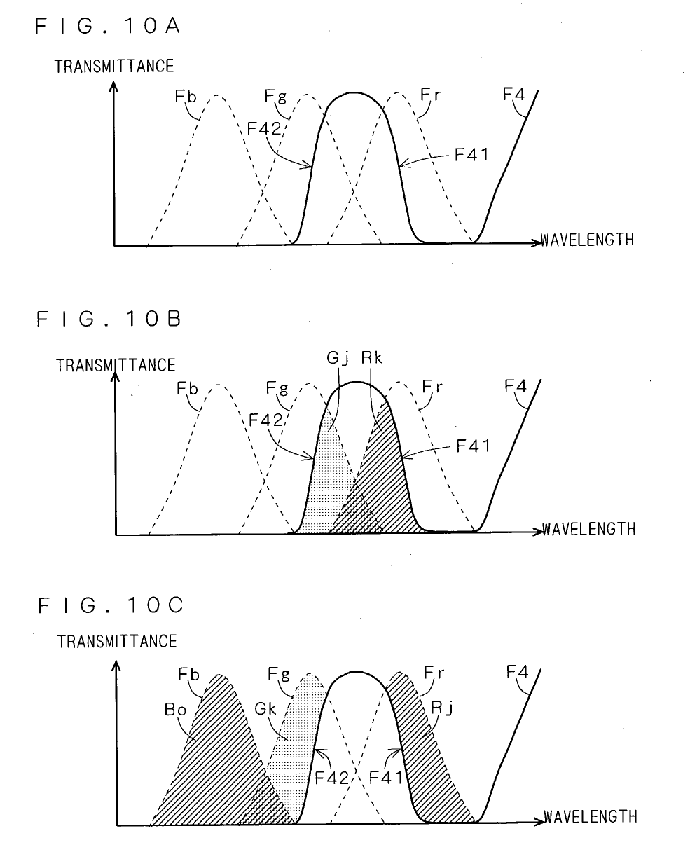

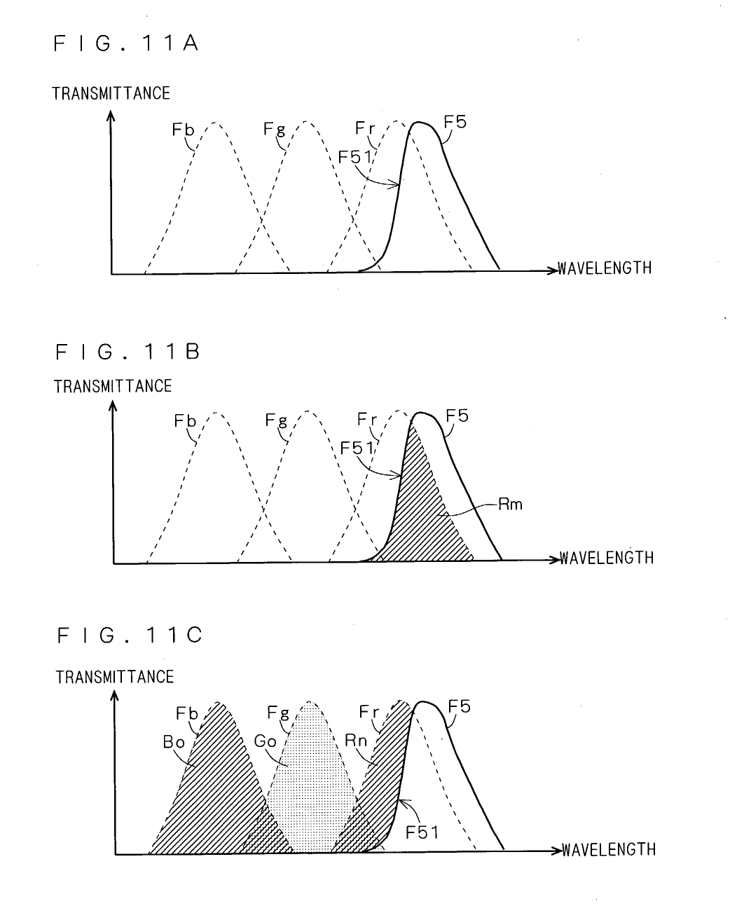

The dichroic film on the spectral surface 31f of the spectral prism 31A does not need to essentially have the wavelength characteristics F1 and F2 dividing each of the three spectral transmission characteristics Fr, Fg and Fb of the image pickup device 32 as shown in FIGS. 3A to 3C and FIGS. 5A to 5C but may have wavelength characteristics F3 and F4 each dividing two wavelength bands as shown in FIGS. 9A to 9C and FIGS. 10A to 10C.

As shown in FIG. 9A, the light components of the wavelength band of the color G expressed by the spectral transmission characteristic Fg are divided into first and second portions by an inclined portion F31 of the wavelength characteristic F3, and a portion corresponding to the low wavelength side selectively transmits. On the other hand, the light components of the wavelength band of the color B expressed by the spectral transmission characteristic Fb are divided into first and second portions by an inclined portion F32, and a portion corresponding to the high wavelength side selectively transmits. By the wavelength characteristic F3 of the spectral surface 31f, in the optical path La in which the incident light Lo transmits, light components on the side lower than the curve expressing the wavelength characteristic F3 propagate. In the optical path Lb to which the incident light Lo is reflected, light components on the side upper than the curve of the wavelength characteristic F3 propagate.

Therefore, a light image of the subject SB transmitting the spectral face 31f and propagating on the optical path La is obtained by the image pickup device 32a as shown in FIG. 9B. Specifically, by G pixels of the image pickup device 32a, a spectral image in a wavelength band Gi (halftone dotted portion) on the left side (low band side) of the inclined portion F31 is obtained. By B pixels of the image pickup device 32a, a spectral image in a wavelength band Bh (hatched portion) on the right side (high band side) of the inclined portion F32 is obtained.

A light image of the subject SB reflected by the spectral face 31f and propagating on the optical path Lb is obtained by the image pickup device 32b as shown in FIG. 9C. Specifically, by R pixels of the image pickup device 32b, since there is no inclined portion of the spectral transmission characteristic F3, a spectral image with respect to a wavelength band Ro of a color filter of the color R is obtained. By G pixels of the image pickup device 32b, a spectral image in a wavelength band Gh (halftone dotted portion) on the right side (high band side) of the inclined portion F31 is obtained. Further, by B pixels of the image pickup device 32b, a spectral image in a wavelength band Bi (hatched portion) on the left side (low band side) of the inclined portion F32 is obtained.

On the other hand, as shown in FIG. 10A, the light components of the wavelength band of the color R expressed by the spectral transmission characteristic Fr are divided into first and second portions by an inclined portion F41 of the wavelength characteristic F4, and a portion corresponding to the low wavelength side selectively transmits. The light components of the wavelength band of the color G expressed by the spectral transmission characteristic Fg are divided into first and second portions by an inclined portion F42, and a portion corresponding to the high wavelength side selectively transmits. By the wavelength characteristic F4 of the spectral surface 31f, in the optical path La in which the incident light Lo transmits, light components on the side lower than the curve expressing the wavelength characteristic F4 propagate. In the optical path Lb to which the incident light Lo is reflected, light components on the side upper than the curve of the wavelength characteristic F4 propagate.

Therefore, a light image of the subject SB transmitting the spectral face 31f and propagating on the optical path La is obtained by the image pickup device 32a as shown by FIG. 10B. Specifically, by R pixels of the image pickup device 32a, a spectral image in a wavelength band Rk (hatched portion) on the left side (low band side) of the inclined portion F41 is obtained. By G pixels of the image pickup device 32a, a spectral image in the wavelength band Gi (halftone dotted portion) on the right side (high band side) of the inclined portion F42 is obtained.

A light image of the subject SB reflected by the spectral face 31f and propagating on the optical path Lb is obtained by the image pickup device 32b as shown in FIG. 10C. Specifically, by R pixels of the image pickup device 32b, a spectral image in a wavelength band Rj (hatched portion) on the right side (high band side) of the inclined portion F41 is obtained. By G pixels of the image pickup device 32b, a spectral image in a wavelength band Gk (halftone dotted portion) on the left side (low band side) of the inclined portion F42 is obtained. Further, by B pixels of the image pickup device 32b, since no inclined portion of the wavelength characteristic F4 exists, a spectral image in a wavelength band Bo of a color filter of B color is obtained.

As described above, also by the spectral prism 31A having the spectral transmission characteristics F3 and F4 shown in FIGS. 9A to 9C and FIGS. 10A to 10C, spectral images of the five wavelength bands Ro, Gh, Gi, Bh and Bi shown in FIGS. 9A to 9C or five wavelength bands Rj, Rk, Gj, Gk and Bo shown in FIGS. 10A to 10C, that is, spectral images of five colors can be obtained with high efficiency regarding the quantity of light.

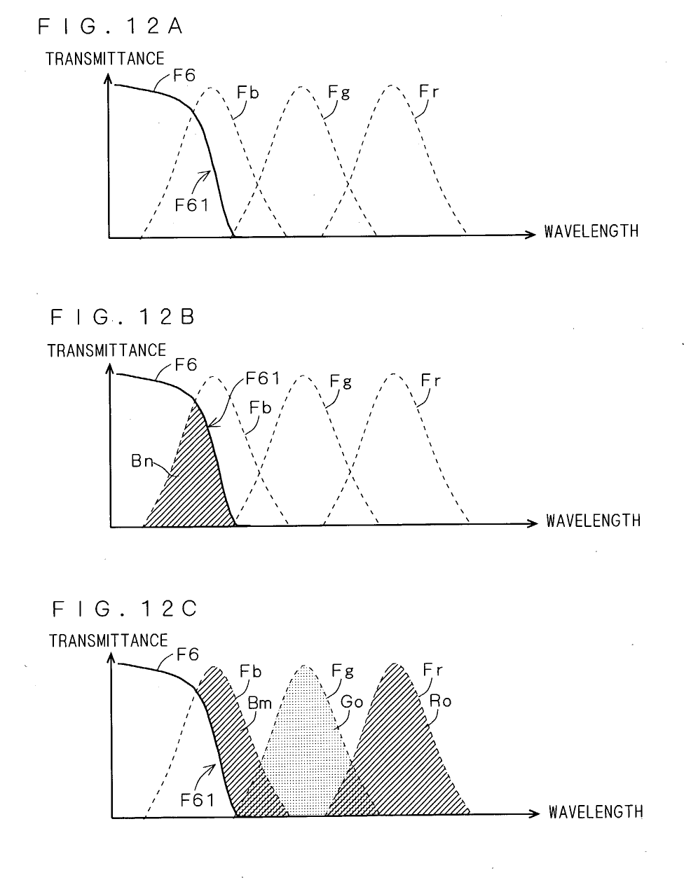

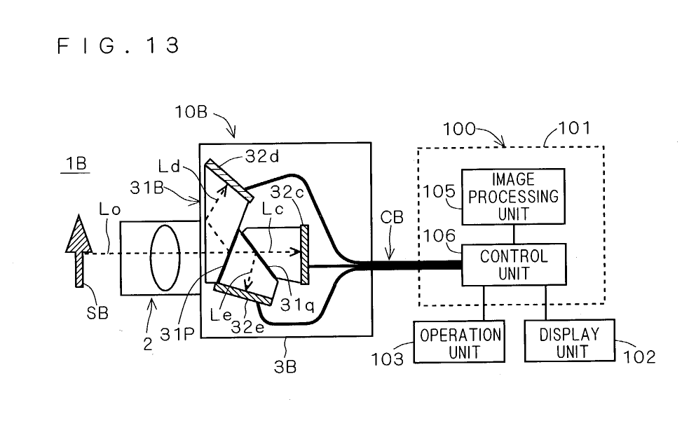

Similarly, the dichroic film on the spectral surface 31f of the spectral prism 31A may have spectral transmission characteristics F5 and F6 each dividing only one wavelength band as shown in FIGS. 11A to 11C and FIGS. 12A to 12C.

As shown in FIG. 11A, the light components of the wavelength band of the color R expressed by the spectral transmission characteristic Fr are divided into first and second portions by an inclined portion F51 of the wavelength characteristic F5, and a portion corresponding to the high wavelength side selectively transmits. By the wavelength characteristic F5 of the spectral face 31f, in the optical path La in which the incident light Lo transmits, light components on the side lower than the curve expressing the wavelength characteristic F5 propagate. In the optical path Lb to which the incident light Lo is reflected, light components on the side upper than the curve of the wavelength characteristic F5 propagate.

Therefore, a light image of the subject SB transmitting the spectral face 31f and propagating on the optical path La is obtained by the image pickup device 32a as shown in FIG. 11B. Specifically, by R pixels of the image pickup device 32a, a spectral image in a wavelength band Rm (hatched portion) on the right side (high band side) of the inclined portion F51 is obtained.

A light image of the subject SB reflected by the spectral face 31f and propagating on the optical path Lb is obtained by the image pickup device 32b as shown in FIG. 11C. Specifically, by R pixels of the image pickup device 32b, a spectral image in a wavelength band Rn (hatched portion) on the left side (low band side) of the inclined portion F51 is obtained. By the G pixels and B pixels of the image pickup device 32b, since no inclined portion of the spectral transmission characteristic F5 exists, spectral images in wavelength bands Go and Bo of the color filters of G and B colors are obtained.

On the other hand, as shown in FIG. 12A, the light components of the wavelength band of the color B expressed by the spectral transmission characteristic Fb are divided into first and second portions by an inclined portion F61 of the wavelength characteristic F6, and a portion corresponding to the low wavelength side selectively transmits. By the wavelength characteristic F6 of the spectral face 31f, in the optical path La in which the incident light Lo transmits, light components on the side lower than the curve expressing the wavelength characteristic F6 propagate. In the optical path Lb to which the incident light Lo is reflected, light components on the side upper than the curve of the wavelength characteristic F6 propagate.

Therefore, a light image of the subject SB transmitting the spectral face 31f and propagating on the optical path La is obtained by the image pickup device 32a as shown in FIG. 12B. Specifically, by B pixels of the image pickup device 32a, a spectral image in a wavelength band Bn (hatched portion) on the left side (low band side) of the inclined portion F61 is obtained.

A light image of the subject SB reflected by the spectral face 31f and propagating on the optical path Lb is obtained by the image pickup device 32b as shown in FIG. 12C. Specifically, by R and G pixels of the image pickup device 32b, since no inclined portion of the spectral transmission characteristic F6 exists, spectral images in wavelength bands Ro and Go of the color filters of R and G colors are obtained. By B pixels of the image pickup device 32b, a spectral image in a wavelength band Bm (hatched portion) on the right side (high band side) of the inclined portion F61 is obtained.

As described above, also by the spectral prism 31A having the spectral transmission characteristics F5 and F6 shown in FIGS. 11A to 11C and FIGS. 12A to 12C, spectral images of the four wavelength bands Rm, Rn, Go and Bo shown in FIGS. 11A to 11C or four wavelength bands Ro, Go, Bm and Bn shown in FIGS. 12A to 12C, that is, spectral images of four colors can be obtained in the two image pickup devices 32a and 32b with high efficiency regarding the quantity of light.

### Second Embodiment

A image pickup system 1B according to a second embodiment of the present invention has the appearance similar to that of the image pickup system 1A of the first embodiment shown in FIG. 1.

FIG. 13 shows the configuration of the main part of the image pickup system 1B.

The image pickup system 1B includes the personal computer 100 having the same configuration as that in the first embodiment, and an image pickup apparatus 10B which is different from the image pickup apparatus 10A in the first embodiment.

The image pickup apparatus 10B includes a camera body 3B having a spectral prism 31B and three image pickup devices 32c to 32e.

The spectral prism 31B has, different from the spectral prism 31A of the first embodiment, two spectral faces 31p and 31q. The spectral faces 31p and 31q are formed from dichroic films, and split the incident light into an optical path Lc in which the incident light Lo from the subject SB transmits, an optical path Ld to which the incident light Lo is reflected by the spectral face 31p, and an optical path Le to which the incident light Lo is reflected by the spectral face 31q.

In a manner similar to the first embodiment, the image pickup device 32 (32c to 32e) takes the form of a general color CCD in which color filters of red (R), green (G) and blue (B) are arranged, for example, in a Bayer array for each pixel (photoelectric conversion cell). The image pickup device 32c obtains a spectral image of the subject SB transmitting the two spectral faces 31p and 31q and traveling in the optical path Lc. The image pickup device 32d obtains a spectral image of the subject SB traveling in the optical path Ld of reflection light by the spectral face 31p. The image pickup device 32e obtains a spectral image of the subject SB traveling in the optical path Le of reflection light by the spectral face 31q (which will be described later).

A method of obtaining a spectral image by the image pickup apparatus 10B having the above configuration will be described below.

### Method of Obtaining Spectral Image

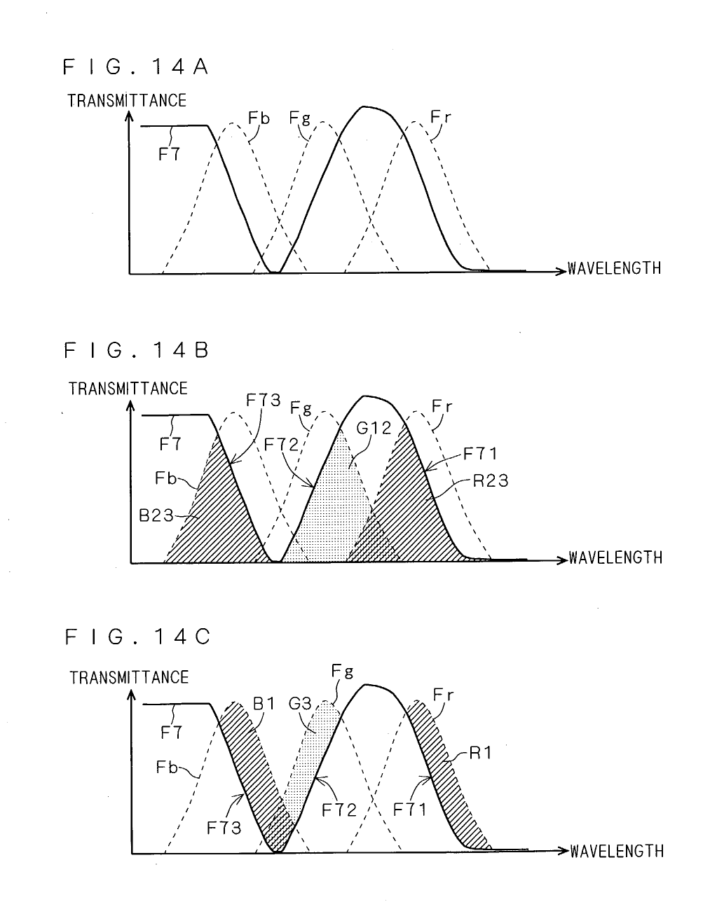

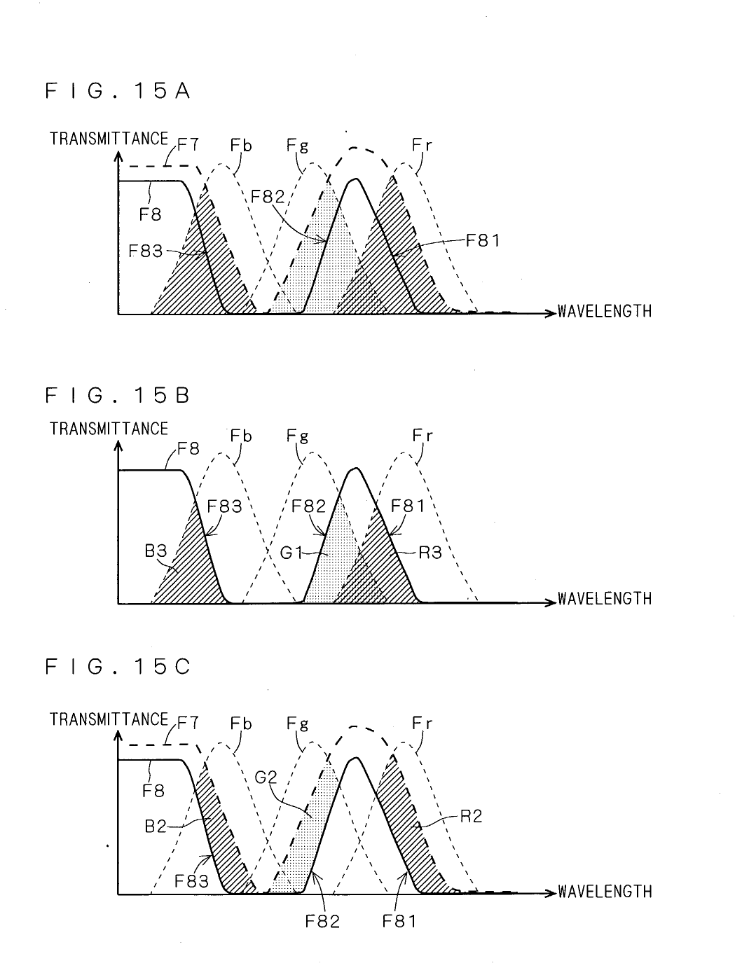

FIGS. 14A to 14C and FIGS. 15A to 15C are graphs for describing a method of obtaining a spectral image by the image pickup apparatus 10B.

As shown in FIG. 14A, the spectral face 31p of a spectral prism 31B has a wavelength characteristic F7 which divides each of the spectral transmission characteristics Fr, Fg and Fb of the color filters of the image pickup device 32.

Concretely, light components in the wavelength band of the color R expressed by the spectral transmission characteristic Fr are divided into first and second portions by an inclined portion F71 of the wavelength characteristic F7 and a portion corresponding to the low wavelength side selectively transmits. On the other hand, light components in the wavelength band of the color G expressed by the spectral transmission characteristic Fg are divided into first and second portions by an inclined portion F72, and a portion corresponding to the high wavelength side selectively transmits. Light components in the wavelength band of the color R expressed by the spectral transmission characteristic Fr are divided into first and second portions by an inclined portion F73, and a portion corresponding to the low wavelength side selectively transmits. By the wavelength characteristic F7 of the spectral face 31p, light components on the side lower than the curve indicating the wavelength characteristic F7 propagate in the optical path Lc in which the incident light Lo transmits and light components on the side upper than the curve indicating the wavelength characteristic F7 propagate in the optical path Ld to which the incident light Lo is reflected.

Therefore, a light image of the subject SB transmitting the spectral face 31p and traveling to the spectral face 31q has the wavelength as shown in FIG. 14B. Specifically, light components in R pixels of the image pickup device 32 are in a wavelength band R23 (hatched portion) on the left side (low band side) of the inclined portion F71. Light components regarding the G pixels of the image pickup device 32 are in a wavelength band G12 (halftone dotted portion) on the right side (high band side) of the inclined portion F72. Further, light components regarding the B pixels in the image pickup device 32 are in a wavelength band B23 (hatched portion) on the left side (low band side) of the inclined portion F73.

A light image of the subject SB reflected by the spectral face 31p and propagating on the optical path Ld is obtained by the image pickup device 32d as shown in FIG. 14C. Specifically, by R pixels of the image pickup device 32d, a spectral image in a wavelength band R1 (hatched portion) on the right side (high band side) of the inclined portion F71 is obtained. By G pixels of the image pickup device 32d, a spectral image in a wavelength band G3 (halftone dotted portion) on the left side (low band side) of the inclined portion F72 is obtained. Further, by B pixels of the image pickup device 32d, a spectral image in a wavelength band B1 (hatched portion) on the right side (high band side) of the inclined portion F73 is obtained.

On the other hand, the spectral face 31q of the spectral prism 31B has a wavelength characteristic F8 which is different from that of the spectral face 31p and splits each of the spectral transmittance characteristics Fr, Fg and Fb of the color filters of the image pickup device 32 as shown in FIG. 15A.

Concretely, light components in the wavelength band of the color R expressed by the spectral transmission characteristic Fr are divided into first and second portions by an inclined portion F81 of the wavelength characteristic F8 and a portion corresponding to the low wavelength side selectively transmits. On the other hand, light components in the wavelength band of the color G expressed by the spectral transmission characteristic Fg are divided into first and second portions by an inclined portion F82, and a portion corresponding to the high wavelength side selectively transmits. Light components in the wavelength band of the color R expressed by the spectral transmission characteristic Fr are divided into first and second portions by an inclined portion F83, and a portion corresponding to the low wavelength side selectively transmits. By the spectral face 31q, light components on the side lower than the curve expressing the wavelength characteristic F8 propagate in the optical path Lc in which the incident light Lo transmits and light components on the side upper than the curve expressing the wavelength characteristic F8 propagate in the optical path Le in which the incident light Lo is reflected.

Therefore, a light image of the subject SB transmitting the spectral face 31q and propagating on the optical path Lc is obtained by the image pickup device 32c as shown by FIG. 15B. Specifically, by R pixels of the image pickup device 32c, a spectral image in a wavelength band R3 (hatched portion) on the left side (low band side) of the inclined portion F81 is obtained. By G pixels of the image pickup device 32c, a spectral image in a wavelength band G1 (halftone dotted portion) on the right side (high band side) of the inclined portion F82 is obtained. Further, by B pixels of the image pickup device 32c, a spectral image in a wavelength band B3 (hatched portion) on the left side (low band side) of the inclined portion F83 is obtained.

A light image of the subject SB reflected by the spectral face 31q and propagating on the optical path Le is obtained by the image pickup device 32e as shown in FIG. 15C. Specifically, by R pixels of the image pickup device 32e, a spectral image in a wavelength band R2 (hatched portion) on the right side (high band side) of the inclined portion F81 is obtained. By G pixels of the image pickup device 32e, a spectral image in a wavelength band G2 (halftone dotted portion) on the left side (low band side) of the inclined portion F82 is obtained. Further, by B pixels of the image pickup device 32e, a spectral image in a wavelength band B2 (hatched portion) on the right side (high band side) of the inclined portion F83 is obtained.

In a manner similar to the first embodiment, the incident light Lo transmits or is reflected by the spectral prism 31B on the basis of the spectral transmission characteristic F7 of the spectral face 31p and the spectral transmission characteristic F8 of the spectral face 31q, so that in the three image pickup devices 32c to 32e, spectral images of nine wavelength bands R1 to R3, G1 to G3, and B1 to B3, that is, nine colors can be obtained with excellent efficiency regarding the quantity of light.

### Operation of Image Pickup System 1B

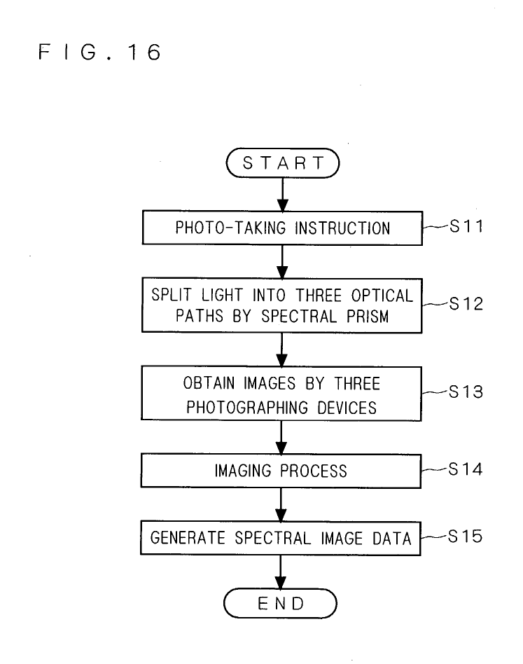

FIG. 16 shows a flowchart for describing the operation of the image pickup system 1B.

In step S11, an operation similar to that in step S1 in the flowchart of FIG. 4 is performed.

In step S12, the incident light Lo from the subject SB is split into the three optical paths Lc to Le by the spectral prism 31B. At this time, by splitting the incident light Lo into transmission light and reflected light by the two spectral faces 31p and 31q, emitting light from the spectral prism 31B is split into three light rays.

In step S13, images are obtained by the three image pickup devices 32c to 32e for receiving light images of the subject SB in the three optical paths Lc to Le split in step S12.

In steps S14 and S15, operations similar to those in steps S4 and S5 shown in the flowchart of FIG. 4 are performed. In step S15, by the wavelength characteristic F7 of the spectral face 31p and the wavelength characteristic F8 of the spectral face 31q dividing each of the three spectral transmission characteristics Fr, Fg and Fb in the image pickup device 32, spectral image data of nine colors (three colors×3) is generated by one-shot image pickup.

By the configuration and operation of the image pickup system 1B, light images of the subject split by the two spectral faces 31p and 31q formed from the dichroic films are obtained by three image pickup devices. Thus, spectral images of nine colors can be obtained easily with excellent efficiency regarding the quantity of light.

### Modifications

A image pickup device in each of the above-described embodiments does not need to essentially have an array of color filters of three primary colors but may have an array of color filters of two colors or four or more colors.

The image pickup device may not essentially split light by a color filter but may split light every wavelength band of RGB by using a characteristic of absorbing light at different depths according to wavelengths of light to be received.

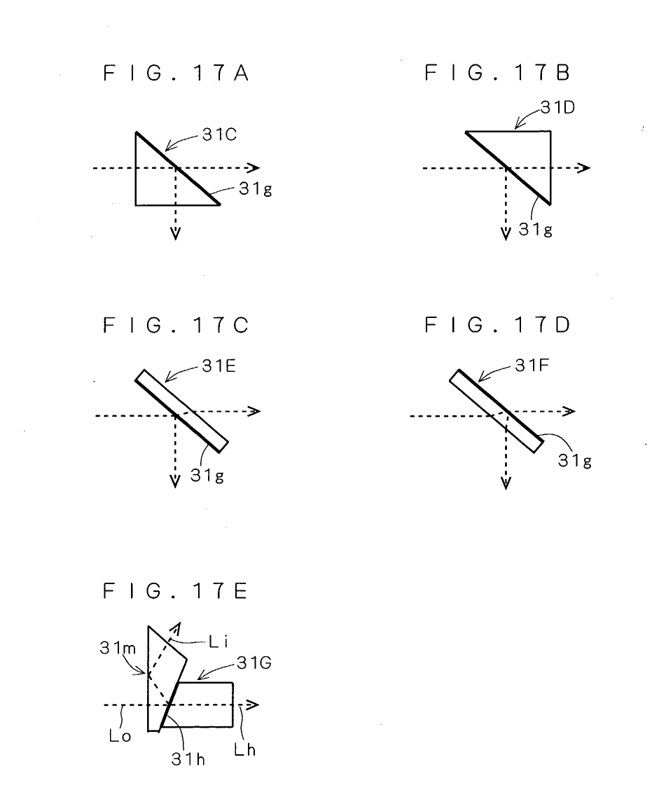

The spectral prism in the first embodiment does not need to essentially have the rectangular parallelepiped shape shown in FIG. 2 but may have any of the shapes shown in FIGS. 17A to 17E.

Each of the spectral prisms 31C and 31D shown in FIGS. 17A and 17B has a triangular prism shape of which bottom face serves as the spectral face 31g and splits light into optical paths which are almost orthogonal to each other.

Each of spectral members 31E and 31F shown in FIGS. 17C and 17D has a rectangular plate shape of which principal face serves as the spectral face 31g and splits light into two optical paths.

Different from the spectral prism shown in FIG. 2, the spectral prism 31G shown in FIG. 17E splits incident light into two optical paths which do not perpendicularly cross each other. Concretely, the spectral prism 31G splits incident light Lo from the subject into two optical paths Lh and Li by a spectral face 31h having a predetermined inclination with respect to the incident light Lo from the subject and a reflection face 31m for reflecting light reflected by the spectral face 31h.

The image pickup system of each of the above-described embodiments is not essentially realized by combination of an image pickup apparatus and a personal computer but may be realized only by an image pickup apparatus in which a user interface corresponding to an operation unit and a display unit of a personal computer is added on a camera.

While the invention has been shown and described in detail, the foregoing description is in all aspects illustrative and not restrictive. It is therefore understood that numerous modifications and variations can be devised without departing from the scope of the invention.

What is claimed is:

1. A image pickup apparatus comprising:
(a) a splitting element for splitting incident light of a subject into a plurality of optical paths by a dichroic film and emitting split light; and
(b) a plurality of image pickup sensors each provided on said plurality of optical paths split by said splitting element, wherein each of said plurality of image pickup sensors has a spectral sensitivity characteristic having a plurality of wavelength bands, and
said dichroic film has a wavelength characteristic of dividing light components in at least one of said plurality of wavelength bands into a first portion and a second portion, and selectively transmitting said first portion.

2. The image pickup apparatus according to claim 1, wherein
said plurality of wavelength bands are three wavelength bands corresponding to three primary colors.

3. The image pickup apparatus according to claim 1, wherein
each of said plurality of image pickup sensors has a color filter array in which a plurality of color filters corresponding to said plurality of wavelength bands are arranged on a photoelectric cell array.

4. The image pickup apparatus according to claim 3, wherein
array patterns of said color filter arrays of said plurality of image pickup sensors are the same.

5. The image pickup apparatus according to claim 1, wherein
said dichroic film has a wavelength characteristic of splitting light components in each of said plurality of wavelength bands into a first portion and a second portion, and selectively transmitting said first portion.

6. The image pickup apparatus according to claim 1, further comprising:
a taking lens system for forming an optical image on image pickup sensors.

7. The image pickup apparatus according to claim 1, wherein
said plurality of wavelength bands are visible light bands.

8. A image pickup system comprising:
(a) an image pickup apparatus including:
a splitting element for splitting incident light of a subject into a plurality of optical paths by a dichroic film and emitting split light; and
a plurality of image pickup sensors each provided on said plurality of optical paths split by said splitting element,
each of said plurality of image pickup sensors having a spectral sensitivity characteristic having a plurality of wavelength bands, and said dichroic film having a wavelength characteristic of dividing light components in at least one of said plurality of wavelength bands into a first portion and a second portion, and selectively transmitting said first portion;
(b) a control unit for controlling acquisition of an image signal of said subject in said image pickup apparatus, and receiving said image signal; and
(c) an image processing unit for performing a predetermined image process on said image signal outputted from said image pickup apparatus.

9. The image pickup system according to claim 8, wherein
said plurality of wavelength bands are three wavelength bands corresponding to three primary colors.

10. The image pickup system according to claim 8, wherein
each of said plurality of image pickup sensors has a color filter array in which a plurality of color filters corresponding to said plurality of wavelength bands are arranged on a photoelectric cell array.

11. The image pickup system according to claim 10, wherein
an array patterns of said color filter arrays of said plurality of image pickup sensors are the same.

12. The image pickup system according to claim 8, wherein
said dichroic film has a wavelength characteristic of splitting light components in each of said plurality of wavelength bands into said first portion and said second portion, and selectively transmitting said first portion.

13. The image pickup system according to claim 8, further comprising:
an operating unit.

14. The image pickup system according to claim 8, further comprising:
a display unit.

15. A image pickup method comprising the steps of:
(a) splitting incident light of a subject into a plurality of optical paths by a dichroic film and emitting split light; and
(b) receiving emitting light split in said step (a) by each of a plurality of image pickup sensors, wherein
each of said plurality of image pickup sensors has a spectral sensitivity characteristic having a plurality of wavelength bands, and said dichroic film has a wavelength characteristic of dividing light components of at least one of said plurality of wavelength bands into a first portion and a second portion, and selectively transmitting said first portion.
